(19) United States
(12) Patent Application Publication
(10) Pub. No.: US 2005/0153238 A1
(43) Pub. Date: Jul. 14, 2005

(54) Photosensitive polyimide resin composition, insulating film using the same, process for producing insulating film, and electronic component using the insulating film

(75) Inventors: Yuki Honda, Hitachi (JP); Hiroyuki Kagawa, Hitachinaka (JP); Shigeki Yamada, Hitachi (JP); Seiji Kamimura, Hitachi (JP); Takahiro Satou, Hitachi (JP)

Correspondence Address: MCGINN & GIBB, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 11/008,651

(22) Filed: Dec. 10, 2004

(30) Foreign Application Priority Data
Dec. 12, 2003 (JP) 2003-415721
Oct. 15, 2004 (JP) 2004-301510

(51) Int. Cl. G03C 1/76

(52) U.S. Cl. 430/270.1

(57) ABSTRACT

A photosensitive polyimide resin composition has: a polyimide resin composition having a polyimide copolymer that is prepared by an imidation reaction of an acid dianhydride with a diamine; and a photosensitizer added to the polyimide resin composition. The polyimide copolymer has a polyimide constitutional unit-to-substituent ratio of 200 to 600, and the polyimide constitutional unit-to-substituent ratio is defined as C=A/B, where A represents a molecular weight of a repeating unit in a polyimide main chain constituting the polyimide copolymer, and B represents a total number of substituents in the repeating unit.

The present application is based on Japanese patent application Nos. 2003-415721 and 2004-301510, the entire contents of which are incorporated herein by reference.

### BACKGROUND OF THE INVENTION

1. Field of the Invention

The invention relates to a photosensitive polyimide resin composition, an insulating film using the same, a process for producing the insulating film, and an electronic component using the insulating film. More particularly, the invention relates to a photosensitive polyimide resin composition, which can be heat-cured and can maintain the shape of the insulating film even at a temperature of 100° C. or above and 200° C. or below, and, further, can prevent peeling of the insulating film and electrical short-circuiting between a plurality of films, and can perform the contemplated function of the electronic component, an insulating film using the same, a process for producing the insulating film, and an electronic component using the insulating film which can be applied even onto a substrate of a material having low heat resistance.

2. Description of the Related Art

In an organic electroluminescent element which emits light from a luminescent layer upon the supply of a drive current across electrodes, it is known that photosensitive heat resistant materials are used for the formation of partition walls and insulating films in the partitioned pixel parts. For example, a material prepared by adding naphthoquinone diazide to a hydroxyl-containing soluble polyimide is known as a positive-type heat resistant precursor resin having such a property that exposed parts are dissolved by development (see, for example, Japanese Patent Laid-Open No. 60630/1989 (paragraph [0002])).

Further, it is known that a positive-type photosensitive polyimide with high resolution and high percentage residual film can be prepared by adding naphthoquinonediamine to a polyimide precursor (see, for example, Japanese Patent Laid-Open No. 143980/2000 (pages 10 and 11)). In pattern formation of these materials, a high boiling solvent of 200° C. or above is used, and an amic acid component is contained. Therefore, high-temperature treatment is necessary for thermal imidation and removal of the solvent in the final step.

FIG. 1 shows a conventional organic electroluminescent element as an electronic component. This organic electroluminescent element 10 includes a transparent electrode 3 such as ITO provided on a glass substrate 2. A partition wall 14A is formed of a positive-type photosensitive polyimide in a cubic form on the transparent electrode 3, for dividing the transparent electrode into a plurality of partitions. An organic electroluminescent film 16 is provided on the partitioned transparent electrode 3. The end 14a of the partition wall 14A stands up substantially vertically from the transparent electrode 3. That is, the partition walls 14A are rectangular in section.

A schematic production process of this organic electroluminescent element is shown in FIG. 2. In producing this organic electroluminescent element 10, an assembly comprising a glass substrate 2, a transparent electrode 3 such as ITO provided on the glass substrate 2, and a positive-type photosensitive polyimide film 14 formed of a positive-type photosensitive polyimide provided on the transparent electrode 3 is first provided (FIG. 2A). Next, an exposure mask 5 prepared by coating a silver halide photographic emulsion onto a glass substrate is placed on the positive-type photosensitive polyimide film 14 for masking, and ultraviolet light is applied from above the exposure mask 5 (FIG. 2B). Next, development is carried out with an alkaline developing solution to remove the photosensitive polyimide film 14 in its exposed parts while remaining the photosensitive polyimide film 14 in its unexposed parts unremoved. The exposure mask 5 is removed to provide partition walls 14A (FIG. 2C). The partition walls 14A are then masked with a deposition mask 7 formed by forming openings in a thin film of a metal such as stainless steel (FIG. 2D). A hole transport layer, a luminescent layer, and an electron transport layer are then successively formed from above the deposition mask 7 to form an organic electroluminescent film 16 (FIG. 2E). An electrode (not shown) is then formed on the organic electroluminescent film 16, and the deposition mask 7 is removed to complete an organic electroluminescent element 10 (FIG. 2F).

According to the conventional positive-type photosensitive polyimide film, however, for example, as shown in FIG. 2G, since the end 14a of the partition walls 14A is formed substantially vertically to the transparent electrode 3, in some cases, an undeposited part 8 disadvantageously occurs even in an unmasked part on the transparent electrode 3. For this reason, the transparent electrode 3 is exposed, and moisture is likely to enter between the partition walls 14A and the transparent electrode 3. This poses problems including that the organic electroluminescent film 16 is separated, electrical short-circuiting occurs between a plurality of films constituting the organic electroluminescent film 16, and the electronic component cannot perform the contemplated function.

On the other hand, a conventional polyimide resin prepared by reacting an aromatic tetracarboxylic acid dianhydride with an aromatic diamine is resistant to heat and further has excellent physical strength, electrical insulating properties and other properties and, thus, has been suitably used for applications as substrates of flexible printed circuit boards, photoresist films and the like.

Polyimide resins commercialized up to now, however, are insoluble in many general-purpose organic solvents and are soluble only in high-boiling aprotic polar solvents such as N-methylpyrrolidone and dimethylformamide. Therefore, high temperatures are necessary for processing. A rigid glass substrate is usually employed as the substrate for organic electroluminescence. However, the use of plastic substrates such as lightweight and flexible filmy substrates is also expected. Therefore, the formation of an insulating film, which, even when the substrate is formed of a material having low heat resistance, can be satisfactorily cured and does not require any high-temperature processing, is indispensable.

### SUMMARY OF THE INVENTION

Accordingly, it is an object of the invention to provide a photosensitive polyimide composition, an insulating film using the same, a process for producing the insulating film, and an electronic component using the insulating film that can prevent peeling of the insulating film and electrical short-circuiting between a plurality of films, and can perform the contemplated function of the electronic component.

It is another object of the invention to provide a positive-type photosensitive polyimide resin composition which can realize a low-temperature fabrication process in the field of an electronic material typified by an organic electroluminescent film and thus can be heat-cured and can maintain the shape of the insulating film even at a temperature of 100° C. or above and 200° C. or below, an insulating film using the same, a process for producing the insulating film, and an electronic component using the insulating film which can be applied even onto a substrate of a material having low heat resistance.

(1) According to one aspect of the invention, a photosensitive polyimide resin composition comprises:
a polyimide resin composition comprising a polyimide copolymer that is prepared by an imidation reaction of an acid dianhydride with a diamine; and
a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
   C=A/B,
where A represents a molecular weight of a repeating unit in a polyimide main chain constituting the polyimide copolymer, and B represents a total number of substituents in the repeating unit.

(2) According to another aspect of the invention, a photosensitive polyimide resin composition comprises:
a polyimide resin composition comprising a polyimide copolymer that is prepared by an imidation reaction of an acid dianhydride with a diamine, the polyimide copolymer comprising a fluorine atom-containing component; and
a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
   C=A/B,
where A represents a molecular weight of a repeating unit in a polyimide main chain constituting the polyimide copolymer, and B represents a total number of substituents in the repeating unit.

In the above (1) and (2), it is preferable that the polyimide copolymer is prepared by dissolving the acid dianhydride and the diamine in a solvent in the presence of a lactone-based catalyst and conducting direct imidation and has a weight average molecular weight of 5000 to 300000.

(3) According to a further aspect of the invention, an insulating film provided on a flat plate, both ends of the insulating film comprising a predetermined taper angle to the flat plate face, comprises:
a photosensitive polyimide resin composition that comprises: a polyimide resin composition comprising a polyimide copolymer that is prepared by an imidation reaction of an acid dianhydride with a diamine; and a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
   C=A/B,
where A represents a molecular weight of a repeating unit in a polyimide main chain constituting the polyimide copolymer, and B represents a total number of substituents in the repeating unit.

(4) According to a further aspect of the invention, an insulating film provided on a flat plate, both ends of the insulating film comprising a predetermined taper angle to the flat plate face, comprises:
a photosensitive polyimide resin composition that comprises: a polyimide resin composition comprising a polyimide copolymer that is prepared by an imidation reaction of an acid dianhydride with a diamine, the polyimide copolymer comprising a fluorine atom-containing component; and a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
   C=A/B,
where A represents a molecular weight of a repeating unit in a polyimide main chain constituting the polyimide copolymer, and B represents a total number of substituents in the repeating unit.

In the above (3) and (4), it is preferable that the predetermined taper angle is 10 to 30 degrees.

(5) According to a further aspect of the invention, a method for forming an insulating film comprises the steps of:
coating a photosensitive polyimide resin composition that is prepared by adding a photosensitizer to a polyimide resin composition comprising a polyimide copolymer, onto a flat plate;
masking the photosensitive polyimide resin composition;
exposing the photosensitive polyimide resin composition to light; and
developing and heating the photosensitive polyimide resin composition to remove unnecessary parts and to form an insulating film,
wherein the polyimide copolymer has a polyimide constitutional unit-to-substituent ratio of 200 to 600, and the polyimide constitutional unit-to-substituent ratio is defined as C represented by equation:
   C=A/B,
where A represents a molecular weight of a repeating unit in a polyimide main chain constituting the polyimide copolymer, and B represents a total number of substituents in the repeating unit.

(6) According to a further aspect of the invention, a method for forming an insulating film comprises the steps of:
coating a photosensitive polyimide resin composition that is prepared by adding a photosensitizer to a polyimide resin composition comprising a polyimide copolymer that comprises a fluorine atom-containing component, onto a flat plate;
masking the photosensitive polyimide resin composition;
exposing the photosensitive polyimide resin composition to light; and
developing and heating the photosensitive polyimide resin composition to remove unnecessary parts and to form an insulating film,
wherein the polyimide copolymer has a polyimide constitutional unit-to-substituent ratio of 200 to 600, and the polyimide constitutional unit-to-substituent ratio is defined as C represented by equation:
   C=A/B,
where A represents a molecular weight of a repeating unit in a polyimide main chain constituting the polyimide copolymer, and B represents a total number of substituents in the repeating unit.

(7) According to a further aspect of the invention, an electronic component comprises:
a substrate;
an electrode provided on the substrate;
a plurality of filmy elements formed of an organic electroluminescent film disposed in a predetermined pattern on the electrode; and
a partition wall that insulates and partitions between the plurality of filmy elements on the electrode,
wherein the partition wall comprises an end formed to have a predetermined taper angle to the surface of the electrode, and the plurality of filmy elements comprise an end formed to be superimposed on the end of the partition wall.

In the above (7), it is preferable that (i) the partition wall comprises a photosensitive polyimide resin composition that comprises: a polyimide resin composition comprising a polyimide copolymer that is prepared by an imidation reaction of an acid dianhydride with a diamine; and a photosensitizer added to the polyimide resin composition, (ii) the polyimide copolymer has a polyimide constitutional unit-to-substituent ratio of 200 to 600, and (iii) the polyimide constitutional unit-to-substituent ratio is defined as C represented by equation: C=A/B, where A represents a molecular weight of a repeating unit in a polyimide main chain constituting the polyimide copolymer, and B represents a total number of substituents in the repeating unit.

In the above (7), it is further preferable that (i) the polyimide copolymer is prepared by dissolving the acid dianhydride and the diamine in a solvent in the presence of a lactone-based catalyst and conducting direct imidation, and (ii) the polyimide copolymer has a weight average molecular weight of 5000 to 300000.

In the above (7), it is preferable that the predetermined taper angle is 10 to 30 degrees.

In the above (7), it is preferable that the substrate is a transparent substrate such as a glass substrate, and the electrode is a transparent electrode such as an ITO electrode.

Advantages of the Invention

In the photosensitive polyimide resin composition according to the invention, since the polyimide constitutional unit-to-substituent ratio C is 200 to 600, when this photosensitive polyimide resin composition is coated and heated as an insulating film onto an electronic component or the like mounted on a substrate, the end of the insulating film and the substrate are joined to each other at a small angle. Therefore, no gap is formed between the insulating film and the substrate, and, thus, the mounted component can be protected.

In the photosensitive polyimide resin composition according to the invention, since a polyimide resin composition comprising a polyimide copolymer comprising a fluorine atom-containing component is used, application to the field of an electronic material in a low-temperature fabrication process at 100° C. or above and 200° C. or below is possible while maintaining excellent heat resisting properties.

In the photosensitive polyimide resin composition according to the invention, since a polyimide copolymer prepared by dissolving an acid dianhydride and a diamine in a solvent in the presence of a lactone-based catalyst and conducting direct imidation and having a weight average molecular weight of 5000 to 300000 is used, requirements for mechanical strength and film forming properties at the time of coating of the photosensitive polyimide resin composition to form a film can be satisfied.

In the insulating film according to the invention, since a photosensitive polyimide resin composition in which the polyimide constitutional unit-to-substituent ratio C is 200 to 600 is used, when this photosensitive polyimide resin composition is coated as an insulating film onto an electronic component or the like mounted on a substrate, the end of the insulating film and the substrate are joined to each other at a small angle. Therefore, when the insulating film is coated so as to be superimposed on the substrate, no gap is formed between the substrate and the insulating film. This can prevent an electronic component or the like from coming into direct contact with outside air, and, thus, electronic component and the like can be protected.

Further, in the insulating film according to the invention, since a polyimide resin composition comprising a polyimide copolymer comprising a fluorine atom-containing component is used, a temperature of 100° C. or above and 200° C. or below suffices for heating the insulating film. Therefore, the insulating film can be satisfactorily cured at a low temperature. This can realize a low-temperature fabrication process in the field of electronic materials typified by organic electroluminescent films. In particular, an organic electroluminescent display can be provided in which a substrate of a material having low heat resistance can be used, the partition walls can be satisfactorily cured and, at the same time, the shape of the partition walls can be maintained.

In the insulating film according to the invention, since the taper angle is 10 to 30 degrees, when the photosensitive polyimide resin composition is coated as an insulating film onto a substrate, the end of the insulating film and the substrate are joined to each other at a small angle. Therefore, when the insulating film is coated so as to be superimposed on the substrate, no gap is formed between the substrate and the insulating film. This can prevent the substrate from coming into direct contact with outside air, and, thus, the substrate can be protected.

In the method for forming an insulating film according to the invention, since a photosensitive polyimide resin composition in which the polyimide constitutional unit-to-substituent ratio C is 200 to 600 is coated as an insulating film onto an electronic component or the like mounted on a substrate, the end of the insulating film stands up from the substrate at a small angle. Therefore, when the insulating film is coated so as to be superimposed on the substrate, no gap is formed between the substrate and the insulating film. This can prevent an electronic component or the like from coming into direct contact with outside air, and, thus, electronic component and the like can be protected.

Further, in the method for forming an insulating film according to the invention, since a polyimide resin composition comprising a polyimide copolymer comprising a fluorine atom-containing component is coated, a temperature of 100° C. or above and 200° C. or below suffices for heating the insulating film. Therefore, the insulating film can be satisfactorily cured at a low temperature. This can realize a low-temperature fabrication process in the field of electronic materials typified by organic electroluminescent films.

In the electronic component according to the invention, since an filmy element is formed so as to be superimposed on the partition wall in its tapered end, no gap is formed between the filmy element and the partition wall. Therefore, a failure of joining of the filmy element can be prevented.

In the electronic component according to the invention, since a photosensitive polyimide resin composition in which the polyimide constitutional unit-to-substituent ratio C is 200 to 600 is used, the end of the insulating film stands up from the substrate at a small angle. Therefore, when the insulating film is coated so as to be superimposed on the substrate, no gap is formed between the substrate and the insulating film. This can prevent an electronic component or the like from coming into direct contact with outside air, and, thus, electronic component and the like can be protected.

In the electronic component according to the invention, since a photosensitive polyimide resin composition in which the weight average molecular weight is 5000 to 300000 is used, requirements for mechanical strength and film forming properties of a protective film formed by coating the photosensitive polyimide resin composition can be satisfied.

In the electronic component according to the invention, since the taper angle is 10 to 30 degrees, when the photosensitive polyimide resin composition is coated as an insulating film onto a substrate, the end of the insulating film and the substrate are joined to each other at a small angle. Therefore, when the insulating film is coated so as to be superimposed on the substrate, no gap is formed between the substrate and the insulating film. This can prevent the substrate from coming into direct contact with outside air, and, thus, the substrate can be protected.

In the electronic component according to the invention, the substrate is a transparent substrate such as a glass substrate, and the electrode is a transparent electrode such as an ITO electrode. Therefore, emitted light can be taken out with high efficiency.

### BRIEF DESCRIPTION OF THE DRAWINGS

The preferred embodiments according to the invention will be explained below referring to the drawings, wherein:

FIG. 1 is a cross-sectional view of a conventional organic electroluminescent element;

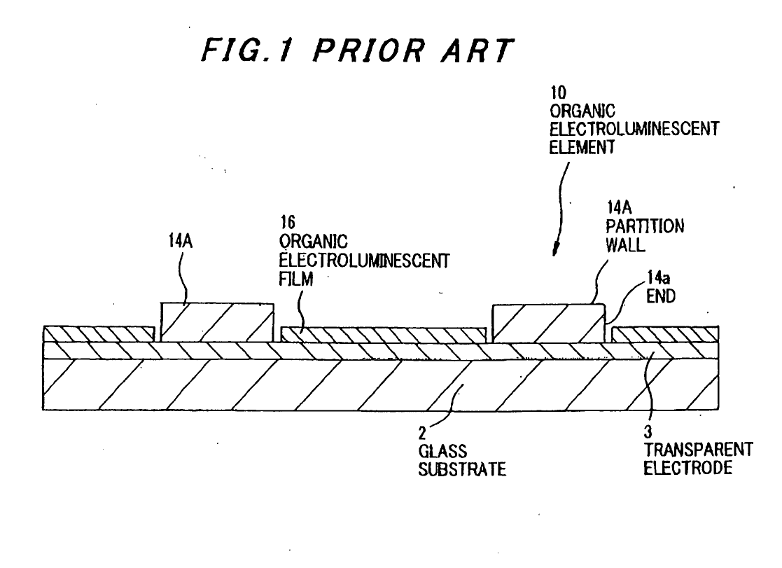

FIG. 2 is a cross-sectional view illustrating a schematic production process of a conventional organic electroluminescent element;

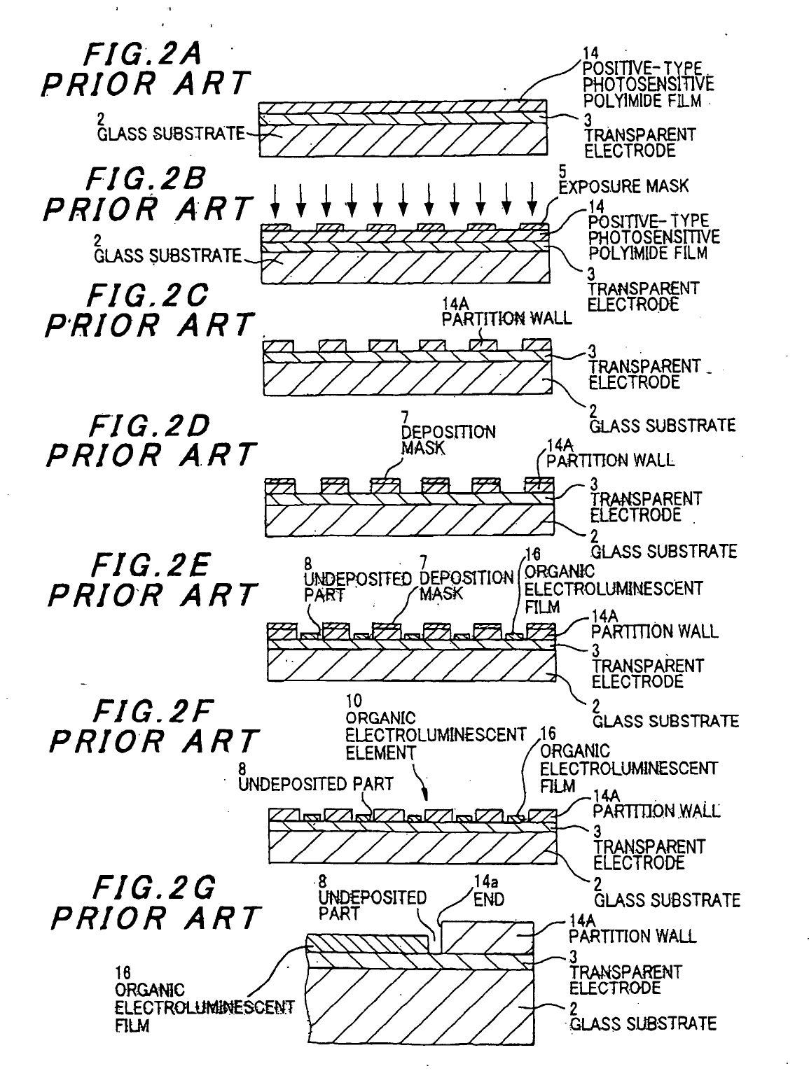

FIG. 3 is a cross-sectional view of an organic electroluminescent element to which a protective film in an embodiment of the invention has been applied; and

FIG. 4 is a cross-sectional view illustrating a schematic production process of an organic electroluminescent element to which a protective film in an embodiment of the invention has been applied.

### DESCRIPTION OF THE PREFERRED EMBODIMENTS

(Whole Construction)

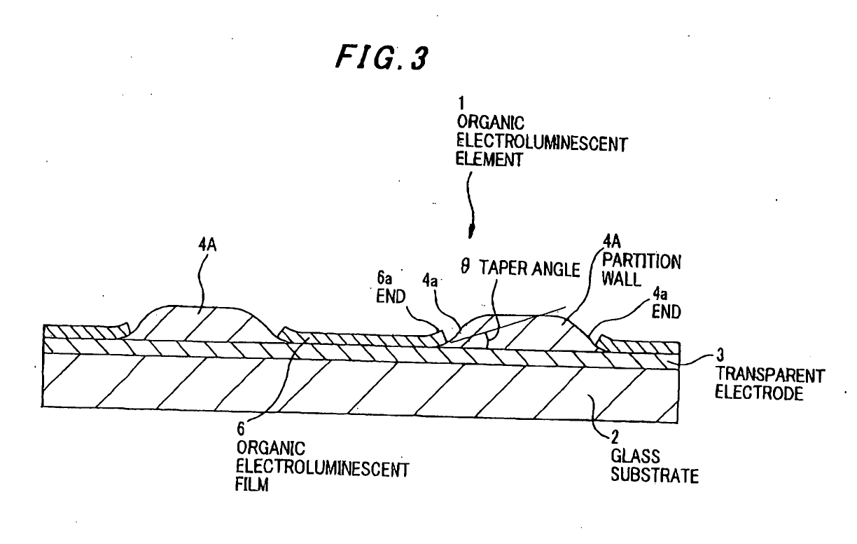

An organic electroluminescent element to which a protective film in an embodiment of the invention has been applied is shown in FIG. 3. This organic electroluminescent element 1 includes a transparent electrode 3 such as ITO provided on a glass substrate 2. A partition wall 4A is formed of a positive-type photosensitive polyimide three-dimensionally on the transparent electrode 3, for dividing the transparent electrode into a plurality of partitions. An organic electroluminescent film 6 is provided on the partitioned transparent electrode 3. The end 4a of the partition wall 4A is provided so as to stand up from the transparent electrode 3 at a small taper angle θ.

Here the positive-type photosensitive polyimide is produced by adding a photosensitizer to a polyimide resin composition comprising a polyimide copolymer prepared by an imidation reaction of an acid dianhydride with a diamine.

(Production Process)

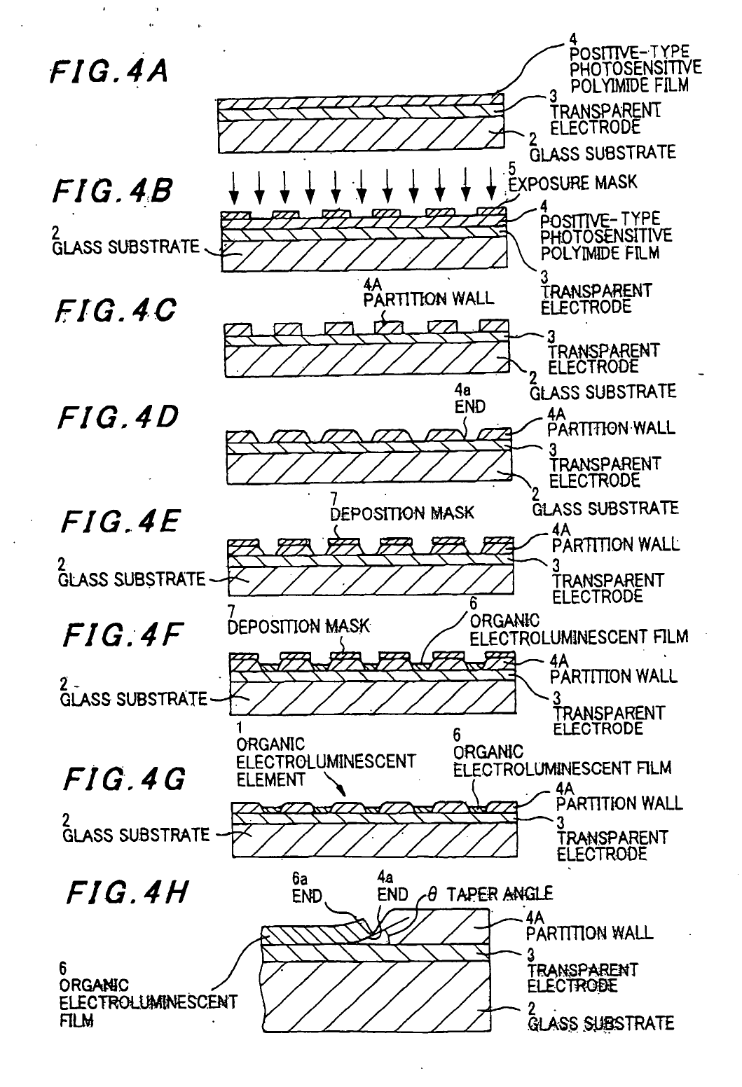

A schematic production process of this organic electroluminescent element is shown in FIG. 4. In producing this organic electroluminescent element 1, an assembly comprising a glass substrate 2, a transparent electrode 3 such as ITO provided on the glass substrate 2, and a positive-type photosensitive polyimide film 4 formed of a positive-type photosensitive polyimide provided on the transparent electrode 3 is first provided (FIG. 4A). Next, an exposure mask 5 prepared by coating a silver halide photographic emulsion onto a glass substrate is placed on the positive-type photosensitive polyimide film for masking, and ultraviolet light is applied from above the exposure mask 5 (FIG. 4B). Next, development with an alkaline developing solution is carried out to remove the positive-type photosensitive polyimide film 4 in its exposed parts while remaining the positive-type photosensitive polyimide film 4 in its unexposed parts unremoved. The exposure mask 5 is removed to provide partition walls 4A (FIG. 4C). Next, the partition walls 4A are heat treated to join the transparent electrode to the partition walls 4A at a predetermined angle (FIG. 4D). The partition walls 4A are then masked with a deposition mask 7 formed by forming openings in a thin film of a metal such as stainless steel (FIG. 4E). A hole transport layer, a luminescent layer, and an electron transport layer are then successively vapor deposited from above the deposition mask 7 to form an organic electroluminescent film 6 (FIG. 4F). An electrode (not shown) is then formed on the organic electroluminescent film 6, and the deposition mask 7 is removed to complete an organic electroluminescent element.

Here the end 4a of the partition wall 4A is in contact with the transparent electrode 3 at a taper angle θ. When the organic electroluminescent film 6 is formed, the end 6a of the organic electroluminescent film 6 is formed so as to overlap with the end 4a of the partition wall 4A.

Each item for embodiments will be explained.

(Solubility of Positive-Type Photosensitive Polyimide)

The polyimide in the positive-type photosensitive polyimide can be made soluble by imparting a hydroxyl or carboxyl group as a substituent. When the hydroxyl or carboxyl group is present, the solubility of the positive-type photosensitive polyimide in the alkaline solution is higher than a polyimide free from the hydroxyl or carboxyl group. In particular, when the substituent is a phenolic hydroxyl group and, at the same time, when the polyimide constitutional unit value is more than 600, the solubility of the positive-type photosensitive polyimide in the alkali is insufficient. This requires a significant development time and is impractical. On the other hand, when the polyimide constitutional unit value is less than 200, the solubility of the positive-type photosensitive polyimide in the alkali is excessively high and stably preparing the pattern becomes difficult. For this reason, the polyimide constitutional unit value is suitably 200 to 600, preferably 300 to 500.

(Polyimide Constitutional Unit Value)

The term “polyimide constitutional unit value” used herein refers to a value determined by C=A/B wherein C represents polyimide constitutional unit-to-substituent ratio, A represents the molecular weight of a repeating unit in a polyimide main chain constituting the polyimide copolymer in the photosensitive polyimide resin composition, and B represents the total number of hydroxyl or carboxyl groups as substituents in the repeating unit.
(Polyimide constitutional unit) C=(Molecular weight of repeating unit) A/(Total number of hydroxyl or carboxyl groups contained in repeating unit) B

As a result of an experiment, it was found that, when the polyimide constitutional unit value is 200 to 600, an insulating film having a small taper angle θ can be provided. Further, the taper angle θ can be selected by specifying this proportion. The larger the number of hydroxyl or carboxyl groups per polyimide constitutional unit, the smaller the taper angle θ, and the smaller the number of hydroxyl or carboxyl groups per polyimide constitutional unit, the larger the taper angle θ. In the invention, any taper angle between 10 degrees and 30 degrees is possible.

(Polyimide Copolymer)

The polyimide copolymer contained in the photosensitive polyimide resin composition according to the invention has an imide ring formed under heating in the presence of a suitable catalyst and has excellent heat resistance and solvent resistance. This polyimide copolymer is prepared by dissolving a diamine and an acid dianhydride in an organic solvent and subjecting the solution to direct imidation. Alternatively, the polyimide copolymer may be prepared by dissolving a diamine and an acid dianhydride in an organic solvent, allowing a reaction to proceed, then adding at least one of the diamine and the acid dianhydride, and conducting imidation. The molar ratio between the diamine to the acid dianhydride is preferably 0.95 to 1.05 based on one mole of the total amount of the acid dianhydride.

Organic solvents include N-methyl-2-pyrrolidone, dimethylformamide, dimethylacetamide, and y-butyrolactone. They may be used either solely or as a mixture of two or more. Further, in order to improve coatability, solvents such as propylene glycol monomethyl ether acetate, 1-methoxy-2-propanol, butyl cellosolve, and butyl cellosolve acetate may be used either solely or as a mixture of two or more.

(Weight Average Molecular Weight of Polyimide Copolymer)

In the invention, the weight average molecular weight of the polyimide copolymer is preferably in the range of 5000 to 300000. When the weight average molecular weight is less than 5000, the mechanical strength of the film is unsatisfactory and, at the same time, the film formation in the state of varnish is difficult. On the other hand, when the weight average molecular weight exceeds 300000, the storage stability is poor and, in addition, film formation becomes difficult. Therefore, the weight average molecular weight is in the range of 5000 to 300000, more preferably in the range of 10000 to 100000. When a fluorine atom is contained in an amount of 10% by weight or more, in development with an aqueous alkaline solution, the water repellency of the interface of the film is proper. Therefore, for example, permeation through the interface can be suppressed.

(Photosensitizer)

Photosensitizers include diazonaphthoquinone sulfonic ester, 1,4-dihydropyridine, nifedipine, polyhydrostyrene, and t-butoxycarbonyl-containing onium salts. Among them, diazonaphthoquinone compounds such as diazonaphthoquinone sulfonic esters are particularly preferred. The amount of the photosensitizer incorporated should be in the range of 1 to 60 parts by weight, preferably 15 to 45 parts by weight, based on 100 parts by weight on a solid basis of the polyimide. When the amount of the photosensitizer is less than one part by weight, satisfactory photosensitivity cannot be provided. On the other hand, when the amount of the photosensitizer exceeds 60 parts by weight, the film shape cannot be retained. Therefore, satisfactory pattern cannot be provided.

(Heat Treatment)

In some cases, for example, in the case of an imidation reaction in post treatment using a polyamic acid as a polyimide precursor, heat treatment at a high temperature is necessary. In general, heating is carried out at 200 to 350° C. for 1 to 60 min. In the photosensitive polyimide resin composition according to the invention, however, since ring closing of imide has already been completed, there is no need to conduct high temperature treatment necessary for imide ring closure and the photosensitive polyimide resin composition is also stable in a post baking process in the formation of partition walls or insulating film.

(Developing Solution)

Developing solutions include an organic solvent-based developing solution comprising N-methyl-2-pyrrolidone, monoethanolamine, and water, an organic solvent-based developing solution comprising monoethanolamine and water, and an organic solvent-based developing solution comprising N-methyl-2-pyrrolidone and water. If necessary, alcohols such as methanol and ethanol, and aromatic hydrocarbons such as toluene and xylene may be added. Additional developing solutions include aqueous inorganic alkaline solutions such as an aqueous sodium hydroxide solution, an aqueous potassium hydroxide solution, and an aqueous tetramethyl ammonium hydroxide solution. They may be used either solely or as a mixture of two or more. However, the developing solution is not limited to the above solutions.

(Adhesion)

Further, in order to improve adhesion between the inorganic electrode and the glass, the photosensitive polyimide resin composition may contain, in addition to the above indispensable components, a silane coupling agent as an optional component in such an amount that does not lower the heat resistance, that is, in an amount of not more than 30 parts by weight, preferably 0.5 to 20 parts by weight, based on 100 parts by weight on a solid basis of the polyimide. When the amount of the optional component falls within the above-defined range, there is no influence on the photosensitive polyimide resin composition and no problem occurs. Therefore, partition walls having better substrate adhesion can be formed. The photosensitive polyimide resin composition may be diluted in various organic solvents, for example, for viscosity modification purposes. If necessary, for example, additives such as fillers, leveling agents, and antifoaming agents may also be added.

(Coating Method)

The photosensitive polyimide resin composition may be coated onto a substrate by a method such as dipping, roll coating, spinning, die coating, wire bar coating, or screen printing. Thereafter, heat drying and curing are carried out by using an oven or a hot plate. The coating film thus obtained is usually patterned by photolithography or the like. That is, exposure development is carried out to form a desired pattern.

In an embodiment according to the invention, the end of the partition walls is joined to the transparent electrode at a predetermined angle, and the end of the partition walls overlaps with the end of the organic electroluminescent film. Therefore, no gap is formed between the end of the partition walls and the transparent electrode, and, thus, the transparent electrode is not exposed and electrical short-circuiting can be avoided.

In an electronic component comprising partition walls for partitioning the substrate into a plurality of blocks and a protective film provided on the partitioned substrate, the end of the protective film and the end of the partition wall may overlap with each other.

The following examples are presented for illustrative purposes only and are not intended to limit the invention in any way.

### EXAMPLE 1

A vessel comprising a 300-ml separable three-necked flask equipped with a stirrer and a condenser with balls provided with a silicone stoppered trap was provided. 17.77 g of 2,2-bis(3,4-anhydrodicarboxyphenyl)hexafluoropropane (hereinafter referred to as “6FDA”), 6.05 g of 3,3′-dihydroxybenzidine (hereinafter referred to as “HOAB”), and 1.82 g of 3,5-diamino benzoic acid (hereinafter referred to as “DABz”) were placed in the vessel. Further, 0.45 g of γ-caprolactone, 0.63 g of pyridine, 96.8 g of NMP, and 19.4 g of toluene were added thereto. The temperature of the contents of the vessel was raised to 180° C., and a reaction was allowed to proceed for 2 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 16.0 g of white polyimide resin powder. This polyimide powder was brought to a 12% solution of γ-butyrolactone/1-methoxy-2-propanol, and 7.2 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution for one min to form a pattern. Next, the formed polyimide film was heated to 230° C. to remove the solvent. Thus, a colored polyimide film was formed.

The colored polyimide film had a thickness of 2 μm and had a resolution of lines and spaces of 10 μm.

### EXAMPLE 2

A vessel comprising a 300-ml separable three-necked flask equipped with a stirrer and a condenser with balls provided with a silicone stoppered trap was provided. 8.88 g of 6FDA, 2.94 g of 3,4,3,4-biphenyltetracaboxylic dianhydride (hereinafter referred to as “BPDA”), 4.54 g of HOAB, and 1.37 g of DABZ were placed in the vessel. Further, 0.34 g of γ-caprolactone, 0.47 g of pyridine, 66.6 g of NMP, and 13.3 g of toluene were added thereto. The temperature of the contents of the vessel was raised to 180° C., and a reaction was allowed to proceed for 2 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 11.0 g of white polyimide resin powder. This polyimide powder was brought to a 12% solution of γ-butyrolactone/1-methoxy-2-propanol, and 4.95 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution for one min to form a pattern. Next, the formed polyimide film was heated to 230° C. to remove the solvent. Thus, a colored polyimide film was formed.

The colored polyimide film had a thickness of 2 μm and had a resolution of lines and spaces of 10 μm.

### EXAMPLE 3

A vessel comprising a 300-ml separable three-necked flask equipped with a stirrer and a condenser with balls provided with a silicone stoppered trap was provided. 22.2 g of 6FDA and 10.8 g of HOAB were placed in the vessel. Further, 0.60 g of γ-caprolactone, 0.70 g of pyridine, 124.8 g of NMP, and 25 g of toluene were added thereto. The temperature of the contents of the vessel was raised to 180° C., and a reaction was allowed to proceed for 1.5 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 21.8 g of white polyimide resin powder. This polyimide powder was brought to a 12% solution of γ-butyrolactone/1-methoxy-2-propanol, and 14.04 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution for 2 min to form a pattern. Next, the formed polyimide film was heated to 230° C. to remove the solvent. Thus, a colored polyimide film was formed.

The colored polyimide film had a thickness of 2 μm and had a resolution of lines and spaces of 10 μm.

### EXAMPLE 4

A vessel comprising a 300-ml separable three-necked flask equipped with a stirrer and a condenser with balls provided with a silicone stoppered trap was provided. 16.35 g of bicyclo(2,2,2)oct-7-ene-2,3,5,6-tetracarboxylic dianhydride (hereinafter referred to as “BCD”) and 14.3 g of HOAB were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 19.8 g of white polyimide resin powder. This polyimide powder was brought to a 12% solution of y-butyrolactone/1-methoxy-2-propanol, and 10.5 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution for 2 min to form a pattern. Next, the formed polyimide film was heated to 230° C. to remove the solvent. Thus, a colored polyimide film was formed.

The colored polyimide film had a thickness of 2 μm and had a resolution of lines and spaces of 10 μm.

### EXAMPLE 5

A vessel comprising a 300-ml separable three-necked flask equipped with a stirrer and a condenser with balls provided with a silicone stoppered trap was provided. 17.77 g of 6FDA, 1.73 g of HOAB, and 4.87 g of DABz were placed in the vessel. Further, 0.45 g of γ-caprolactone, 0.63 g of pyridine, 97.4 g of NMP, and 19.4 g of toluene were added thereto. The temperature of the contents of the vessel was raised to 180° C., and a reaction was allowed to proceed for 2 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 16.0 g of white polyimide resin powder. This polyimide powder was brought to a 12% solution of γ-butyrolactone/1-methoxy-2-propanol, and 7.2 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution for one min to form a pattern. Next, the formed polyimide film was heated to 230° C. to remove the solvent. Thus, a colored polyimide film was formed.

The colored polyimide film had a thickness of 2 μm and had a resolution of lines and spaces of 10 μm.

### COMPARATIVE EXAMPLE 1

A vessel comprising a 300-ml separable three-necked flask equipped with a stirrer and a condenser with balls provided with a silicone stoppered trap was provided. 12.41 g of BCD, 3.80 g of DABz, 7.35 g of BPDA, 5.41 g of bis{4-(4-aminophenoxy)benzene}(hereinafter referred to as “m-BAPS”), and 4.36 g of hexamethylenediamine (hereinafter referred to as “HMDA”) were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 23.3 g of white polyimide resin powder. This polyimide powder was brought to a 12% solution of γ-butyrolactone/1-methoxy-2-propanol, and 10.5 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution for 3 min to form a pattern. Next, the formed polyimide film was heated to 230° C. to remove the solvent. Thus, a colored polyimide film was formed.

The colored polyimide film had a thickness of 2 μm and had a resolution of lines and spaces of 10 μm. However, the taper angle was 35 degrees, and a gentle taper angle could not be provided.

### COMPARATIVE EXAMPLE 2

A vessel comprising a 300-ml separable three-necked flask equipped with a stirrer and a condenser with balls provided with a silicone stoppered trap was provided. 12.41 g of BCD, 5.01 g of 4,4′-diaminodiphenyl ether (hereinafter referred to as “p-DADE”), 7.35 g of BPDA, 5.41 g of m-BAPS, and 4.36 g of HMDA were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 23.3 g of white polyimide resin powder. This polyimide powder was brought to a 12% solution of γ-butyrolactone/1-methoxy-2-propanol, and 10.5 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution to form a pattern. However, even after immersion for one hr, a satisfactory pattern could not be formed.

### COMPARATIVE EXAMPLE 3

A vessel comprising a 300-ml separable three-necked flask equipped with a stirrer and a condenser with balls provided with a silicone stoppered trap was provided. 13.8 g of 1,2,3,4-cyclopentanetetracarboxylic dianhydride (hereinafter referred to as “CPDA”) and 14.3 g of HOAB were placed in the vessel. Further, 0.86 g of γ-caprolactone, 1.2 g of pyridine, 112.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 19.8 g of white polyimide resin powder. This polyimide powder was brought to a 12% solution of γ-butyrolactone/1-methoxy-2-propanol, and 10.5 g of diazonaphthoquinone was added as a photosensitizer to give a photosensitive polyimide.

This photosensitive polyimide solution was coated onto an alkali-free glass or an ITO substrate, and the coating was then prebaked at 95° C. to form a polyimide film. The polyimide film was exposed through a mask at 300 mJ/cm², followed by development with an alkaline developing solution to form a pattern. However, even after immersion for one hr, a satisfactory pattern could not be formed.

For Examples 1 to 5 and Comparative Examples 1 to 3, the relationship among the ratio of the molecular weight of the constitutional unit of the polyimide to the total number of hydroxyl or carboxyl groups, whether pattern formation after development is possible or impossible, taper angle, and development time is shown in Table 1.

TABLE 1

| | Ratio of molecular weight of constitutional | Possible or impossible | | |
|---|---|---|---|---|
| | unit of polyimide to total number of | to pattern formation | | Development |
| | hydroxyl or carboxyl groups | after development | Taper angle | time |
| Ex. 1 | 326 | Possible | 19 | 1 min |
| Ex. 2 | 355 | Possible | 19 | 1 min |
| Ex. 3 | 321 | Possible | 27 | 2 min |
| Ex. 4 | 220 | Possible | 27 | 2 min |
| Ex. 5 | 477 | Possible | 28 | 2 min |
| Comp. Ex. 1 | 640 | Possible | 35 | 3 min |
| | | | (Not gentle) | |
| Comp. Ex. 2 | Neither hydroxyl group nor | Impossible | — | — |
| | carboxyl group present | | (Impossible to form pattern) | |
| Comp. Ex. 3 | 195 | Impossible | — | — |
| | | | (Impossible to form pattern) | |

The results in Table 1 show that, for Examples 1 to 5, when the ratio of the molecular weight of polyimide constitutional unit to the total number of hydroxyl or carboxyl groups is 200 to 600, pattern formation after development is possible and, further, the taper angle is in the range of 10 to 30 degrees.

### EXAMPLE 6

A vessel comprising a 300-ml separable three-necked flask equipped with a stirrer and a condenser with balls provided with a silicone stoppered trap was provided. 17.77 g of 6FDA, 6.05 g of HOAB, and 1.82 g of DABz were placed in the vessel. Further, 0.45 g of γ-caprolactone, 0.63 g of pyridine, 96.8 g of NMP, and 19.4 g of toluene were added thereto. The temperature of the contents of the vessel was raised to 180° C., and a reaction was allowed to proceed for 2 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 16.0 g of white polyimide resin powder. This polyimide powder was brought to a 12% solution of propylene glycol-1-monomethyl ether, and 7.2 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution for one min to form a pattern. Next, the formed polyimide film was heated to 170° C. to remove the solvent. Thus, a colored polyimide film was formed.

The colored polyimide film had a thickness of 2 μm and had a resolution of lines and spaces of 10 μm.

### EXAMPLE 7

A vessel comprising a 300-ml separable three-necked flask equipped with a stirrer and a condenser with balls provided with a silicone stoppered trap was provided. 8.88 g of 6FDA, 2.94 g of BPDA, 4.54 g of HOAB, and 1.37 g of DABZ were placed in the vessel. Further, 0.34 g of γ-caprolactone, 0.47 g of pyridine, 66.6 g of NMP, and 13.3 g of toluene were added thereto. The temperature of the contents of the vessel was raised to 180° C., and a reaction was allowed to proceed for 2 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 11.0 g of white polyimide resin powder. This polyimide powder was brought to a 12% solution of propylene glycol-1-monomethyl ether, and 4.95 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution for one min to form a pattern. Next, the formed polyimide film was heated to 170° C. to remove the solvent. Thus, a colored polyimide film was formed.

The colored polyimide film had a thickness of 2 μm and had a resolution of lines and spaces of 10 μm.

### EXAMPLE 8

A vessel comprising a 300-ml separable three-necked flask equipped with a stirrer and a condenser with balls provided with a silicone stoppered trap was provided. 22.2 g of 6FDA and 10.8 g of HOAB were placed in the vessel. Further, 0.60 g of γ-caprolactone, 0.70 g of pyridine, 124.8 g of NMP, and 25 g of toluene were added thereto. The temperature of the contents of the vessel was raised to 180° C., and a reaction was allowed to proceed for 1.5 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 21.8 g of white polyimide resin powder. This polyimide powder was brought to a 12% solution of propylene glycol-1-monomethyl ether, and 14.04 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution for 2 min to form a pattern. Next, the formed polyimide film was heated to 170° C. to remove the solvent. Thus, a colored polyimide film was formed.

The colored polyimide film had a thickness of 2 μm and had a resolution of lines and spaces of 10 μm.

### EXAMPLE 9

A vessel comprising a 300-ml separable three-necked flask equipped with a stirrer and a condenser with balls provided with a silicone stoppered trap was provided. 17.77 g of 6FDA, 1.73 g of HOAB, and 4.87 g of DABz were placed in the vessel. Further, 0.45 g of γ-caprolactone, 0.63 g of pyridine, 97.4 g of NMP, and 19.4 g of toluene were added thereto. The temperature of the contents of the vessel was raised to 180° C., and a reaction was allowed to proceed for 2 hr. The speed of rotation of the stirrer was 250 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 16.0 g of white polyimide resin powder. This polyimide powder was brought to a 12% solution of γ-butyrolactone/1-methoxy-2-propanol, and 7.2 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution for one min to form a pattern. Next, the formed polyimide film was heated to 170° C. to remove the solvent. Thus, a colored polyimide film was formed.

The colored polyimide film had a thickness of 2 μm and had a resolution of lines and spaces of 10 μm.

The polyimide powder was soluble in propylene glycol-1-monomethyl ether.

### COMPARATIVE EXAMPLE 4

A vessel comprising a 300-ml separable three-necked flask equipped with a stirrer and a condenser with balls provided with a silicone stoppered trap was provided. 12.41 g of BCD, 3.80 g of DABz, 7.35 g of BPDA, 5.41 g of m-BAPS, and 4.36 g of HMDA were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 23.3 g of white polyimide resin powder. An attempt was made to prepare a 12% solution of the polyimide powder in propylene glycol-1-monomethyl ether. However, the polyimide powder could not be dissolved in propylene glycol-1-monomethyl ether.

### COMPARATIVE EXAMPLE 5

A vessel comprising a 300-ml separable three-necked flask equipped with a stirrer and a condenser with balls provided with a silicone stoppered trap was provided. 12.41 g of BCD, 3.80 g of DABz, 7.35 g of BPDA, 5.41 g of m-BAPS, and 4.36 g of HMDA were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 23.3 g of white polyimide resin powder. An attempt was made to prepare a 12% solution of the polyimide powder in propylene glycol-1-monomethyl ether. However, the polyimide powder could not be dissolved in propylene glycol-1-monomethyl ether. Therefore, the polyimide powder was brought to a 12% solution of γ-butyrolactone/1-methoxy-2-propanol, and 10.5 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution for 3 min to form a pattern. Next, the formed polyimide film was heated to 230° C. to remove the solvent. Thus, a colored polyimide film was formed.

However, the polyethylene terephthalate substrate was significantly warped, and subsequent evaluation could not be carried out.

### COMPARATIVE EXAMPLE 6

A vessel comprising a 300-ml separable three-necked flask equipped with a stirrer and a condenser with balls provided with a silicone stoppered trap was provided. 12.41 g of BCD, 5.01 g of p-DADE, 7.35 g of BPDA, 5.41 g of m-BAPS, and 4.36 g of HMDA were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 23.3 g of white polyimide resin powder. An attempt was made to prepare a 12% solution of the polyimide powder in propylene glycol-1-monomethyl ether. However, the polyimide powder could not be dissolved in propylene glycol-1-monomethyl ether. Therefore, this polyimide powder was brought to a 12% solution of γ-butyrolactone/1-methoxy-2-propanol, and 10.5 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution to form a pattern. However, even after immersion for one hr, a satisfactory pattern could not be formed.

### COMPARATIVE EXAMPLE 7

A vessel comprising a 300-ml separable three-necked flask equipped with a stirrer and a condenser with balls provided with a silicone stoppered trap was provided. 13.8 g of CPDA and 14.3 g of HOAB were placed in the vessel. Further, 0.86 g of γ-caprolactone, 1.2 g of pyridine, 112.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 19.8 g of white polyimide resin powder. An attempt was made to prepare a 12% solution of the polyimide powder in propylene glycol-1-monomethyl ether. However, the polyimide powder could not be dissolved in propylene glycol-1-monomethyl ether. Therefore, this polyimide powder was brought to a 12% solution of γ-butyrolactone/1-methoxy-2-propanol, and 10.5 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution to form a pattern. However, even after immersion for one hr, a satisfactory pattern could not be formed.

### COMPARATIVE EXAMPLE 8

A vessel comprising a 300-ml separable three-necked flask equipped with a stirrer and a condenser with balls provided with a silicone stoppered trap was provided. 16.35 g of BCD and 14.3 g of HOAB were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 19.8 g of white polyimide resin powder. An attempt was made to prepare a 12% solution of the polyimide powder in propylene glycol-1-monomethyl ether. However, the polyimide powder could not be dissolved in propylene glycol-1-monomethyl ether.

### COMPARATIVE EXAMPLE 9

A vessel comprising a 300-ml separable three-necked flask equipped with a stirrer and a condenser with balls provided with a silicone stoppered trap was provided. 16.35 g of BCD and 14.3 g of HOAB were placed in the vessel. Further, 0.86 g of γ-caprolactone, 1.2 g of pyridine, 122.6 g of NMP, and 24.5 g of toluene were added thereto. The temperature of the contents of the vessel was raised to 180° C., and a reaction was allowed to proceed for 5 hr. The speed of rotation of the stirrer was 180 rpm and was properly reduced as the reaction decreased. In this case, water produced during the reaction was removed through the silicone stopper. Thus, a reaction solution (varnish) was obtained. Thereafter, the reaction solution was poured into methanol, and the mixture was stirred at a high speed and was then filtered through a glass filter to give 19.8 g of white polyimide resin powder. An attempt was made to prepare a 12% solution of the polyimide powder in propylene glycol-1-monomethyl ether. However, the polyimide powder could not be dissolved in propylene glycol-1-monomethyl ether. Therefore, the polyimide powder was brought to a 12% solution of y-butyrolactone/1-methoxy-2-propanol, and 10.5 g of diazonaphthoquinone was added as a photosensitizer to give a photosensitive polyimide.

This photosensitive polyimide solution was coated onto a polyethylene terephthalate substrate, and the coating was then prebaked at 95° C. to form a polyimide film. The polyimide film was exposed through a mask at 300 mJ/cm², followed by development with an alkaline developing solution for 2 min to form a pattern. Next, the formed polyimide film was heated to 230° C. to remove the solvent. Thus, a colored polyimide film was formed.

However, the polyethylene terephthalate substrate was significantly warped, and subsequent evaluation could not be carried out.

For Examples 6 to 9 and Comparative Examples 4 to 9, the relationship among solubility in propylene glycol-1-monomethyl ether, the ratio of the molecular weight of the constitutional unit of the polyimide to the total number of hydroxyl or carboxyl groups, whether pattern formation after development is possible or impossible, taper angle, development time, and deformation of the substrate is shown in Table 2.

TABLE 2

| | | Ratio of molecular weight of | | | | |
|---|---|---|---|---|---|---|
| | Solubility in | constitutional unit of | Possible or impossible | | | |
| | propylene glycol- | polyimide to total number | to pattern formation | | Developing | Deformation |
| Classification | 1-monomethyl ether | of hydroxyl or carboxyl groups | after development | Taper angle | time | of substrate |
| Ex. 6 | Soluble | 326 | Possible | 19 | 1 min | Not deformed |
| Ex. 7 | Soluble | 355 | Possible | 19 | 1 min | Not deformed |
| Ex. 8 | Soluble | 321 | Possible | 27 | 2 min | Not deformed |
| Ex. 9 | Soluble | 477 | Possible | 28 | 2 min | Not deformed |
| Comp. Ex. 4 | Insoluble | 640 | Possible | — | — | — |
| Comp. Ex. 5 | Insoluble | 640 | Possible | 35 | 3 min | Deformed |
| | | | | (Not gentle) | | |
| Comp. Ex. 6 | Insoluble | Neither hydroxyl | Impossible | — | — | Deformed |
| | | group nor carboxyl | | (Impossible to | | |
| | | group present | | form pattern) | | |
| Comp. Ex. 7 | Insoluble | 195 | Impossible | — | — | Deformed |
| | | | | (Impossible to | | |
| | | | | form pattern) | | |
| Comp. Ex. 8 | Insoluble | 220 | Possible | — | — | — |
| Comp. Ex. 9 | Insoluble | 220 | Possible | 27 | 2 min | Deformed |

The results in Table 2 show that, for Examples 6 to 9, dissolution in propylene glycol-1-monomethyl ether is possible, the ratio of the molecular weight of polyimide constitutional unit to the total number of hydroxyl or carboxyl groups is in the range of 200 to 600, the pattern formation after development is possible, the taper angle is in the range of 10 to 30 degrees, and deformation of substrate did not occur.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

1. A photosensitive polyimide resin composition, comprising:
a polyimide resin composition comprising a polyimide copolymer that is prepared by an imidation reaction of an acid dianhydride with a diamine; and
a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

2. A photosensitive polyimide resin composition, comprising:
a polyimide resin composition comprising a polyimide copolymer that is prepared by an imidation reaction of an acid dianhydride with a diamine, the polyimide copolymer comprising a fluorine atom-containing component; and
a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

3. The photosensitive polyimide resin composition according to claim 1, wherein:
the polyimide copolymer is prepared by dissolving the acid dianhydride and the diamine in a solvent in the presence of a lactone-based catalyst and conducting direct imidation, and the polyimide copolymer has a weight average molecular weight of 5000 to 300000.

4. The photosensitive polyimide resin composition according to claim 2, wherein:
the polyimide copolymer is prepared by dissolving the acid dianhydride and the diamine in a solvent in the presence of a lactone-based catalyst and conducting direct imidation, and the polyimide copolymer has a weight average molecular weight of 5000 to 300000.

5. An insulating film provided on a flat plate, both ends of the insulating film comprising a predetermined taper angle to the flat plate face, comprising:
a photosensitive polyimide resin composition that comprises: a polyimide resin composition comprising a polyimide copolymer that is prepared by an imidation reaction of an acid dianhydride with a diamine; and a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

6. An insulating film provided on a flat plate, both ends of the insulating film comprising a predetermined taper angle to the flat plate face, comprising:
a photosensitive polyimide resin composition that comprises: a polyimide resin composition comprising a polyimide copolymer that is prepared by an imidation reaction of an acid dianhydride with a diamine, the polyimide copolymer comprising a fluorine atom-containing component; and a photosensitizer added to the polyimide resin composition,
wherein the polyimide copolymer has a polyimide constitutional unit-to-substituent ratio of 200 to 600, and the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

7. The insulating film according to claim 5, wherein:
the predetermined taper angle is 10 to 30 degrees.

8. The insulating film according to claim 6, wherein:
the predetermined taper angle is 10 to 30 degrees.

9. A method for forming an insulating film, comprising the steps of:
coating a photosensitive polyimide resin composition that is prepared by adding a photosensitizer to a polyimide resin composition comprising a polyimide copolymer, onto a flat plate;
masking the photosensitive polyimide resin composition;
exposing the photosensitive polyimide resin composition to light; and
developing and heating the photosensitive polyimide resin composition to remove unnecessary parts and to form an insulating film,
wherein the polyimide copolymer has a polyimide constitutional unit-to-substituent ratio of 200 to 600, and the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

10. A method for forming an insulating film, comprising the steps of:
coating a photosensitive polyimide resin composition that is prepared by adding a photosensitizer to a polyimide resin composition comprising a polyimide copolymer that comprises a fluorine atom-containing component, onto a flat plate;
masking the photosensitive polyimide resin composition;
exposing the photosensitive polyimide resin composition to light; and
developing and heating the photosensitive polyimide resin composition to remove unnecessary parts and to form an insulating film,
wherein the polyimide copolymer has a polyimide constitutional unit-to-substituent ratio of 200 to 600, and the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

11. An electronic component, comprising:
a substrate;
an electrode provided on the substrate;
a plurality of filmy elements formed of an organic electroluminescent film disposed in a predetermined pattern on the electrode; and
a partition wall that insulates and partitions between the plurality of filmy elements on the electrode,
wherein the partition wall comprises an end formed to have a predetermined taper angle to the surface of the electrode, and the plurality of filmy elements comprise an end formed to be superimposed on the end of the partition wall.

12. The electronic component according to claim 11, wherein:
the partition wall comprises a photosensitive polyimide resin composition that comprises: a polyimide resin composition comprising a polyimide copolymer that is prepared by an imidation reaction of an acid dianhydride with a diamine; and a photosensitizer added to the polyimide resin composition,
the polyimide copolymer has a polyimide constitutional unit-to-substituent ratio of 200 to 600, and
the polyimide constitutional unit-to-substituent ratio is defined as C represented by equation:
C=A/B,
where A represents a molecular weight of a repeating unit in a polyimide main chain constituting the polyimide copolymer, and B represents a total number of substituents in the repeating unit.

13. The electronic component according to claim 12, wherein:
the polyimide copolymer is prepared by dissolving the acid dianhydride and the diamine in a solvent in the presence of a lactone-based catalyst and conducting direct imidation, and
the polyimide copolymer has a weight average molecular weight of 5000 to 300000.

14. The electronic component according to claim 11, wherein:
the predetermined taper angle is 10 to 30 degrees.

15. The electronic component according to claim 11, wherein:
the substrate is a transparent substrate, and the electrode is a transparent electrode.
